(19) United States
(12) Patent Application Publication
(10) Pub. No.: US 2004/0066093 A1
(43) Pub. Date: Apr. 8, 2004

(54) Method and system for correcting a power factor of a storage subsystem

(76) Inventor: George E. Hanson, Andover, KS (US)

Correspondence Address: LSI LOGIC CORPORATION, 1621 BARBER LANE, MS: D-106 LEGAL, MILPITAS, CA, 95035, US

(21) Appl. No.: 10/264,386

(22) Filed: Oct. 4, 2002

(51) Int. Cl. H02J 1/00

(52) U.S. Cl. 307/11; 365/226

(57) ABSTRACT

A storage subsystem that utilizes power factor correction circuitry to solve an input current harmonics problem caused by one or more accessory units that are added to the storage subsystem. The circuit may be characterized as a boost AC/AC power converter and utilizes active current shaping to achieve a unity power factor. It utilizes pulse width modulation (PWM) or pulse amplitude modulation (PAM) as a means of accomplishing this shaping. The modulation in the circuitry is controlled by a combination of an inner average-current loop and an outer voltage-control loop. Together, these control loops maintain a regulated output voltage while forcing the input current to be sinusoidal. Using such a circuit may eliminate the necessity of modifying either the power supply of accessory units or the rack electrical distribution system within the storage subsystem.

### FIELD OF THE INVENTION

This invention relates generally to the field of storage subsystems, and particularly to a method and system for correcting a power factor of a storage subsystem.

### BACKGROUND OF THE INVENTION

Electronic data storage is one of the most important aspects of the modern economy. Almost every aspect of modern life has some element that requires the storage of electronic data. As is well known in the art, a storage subsystem is an integrated collection of one or more storage controller modules, one or more data storage devices such as disks, CD-ROMs, tapes, media loaders and the like, and any required control software that provides storage services to one or more computers.

A storage subsystem provides a non-linear load to a power line that is supplying power to the storage subsystem. Thus, it has current acceptance waveforms that do not match the waveforms of the associated voltage. When the current waveform is distorted from the voltage waveform, the normalized difference between that current waveform and the voltage waveform represents a quantitative factor of harmonics injected back onto the power line. Since harmonic currents caused by such a storage subsystem produce voltage harmonics across the public utilities impedance, they may cause serious interference with the operation of other equipment connected to the same circuit as well as overheating power-line transformers. Therefore, conventional power supplies within most data storage subsystems already contain active circuitry that compensates and adjusts power factors so that the current waveforms closely match the voltage waveforms. This is the essence of power factor control. Power factor is defined as the ratio of the actual power (Watts) developed by an AC power system to the apparent power (i.e., volt-amperes). When the AC input current waveform is sinusoidal and in phase with the AC power line voltage, the actual power and the apparent power are identical, i.e., the power factor is unity, and optimal power distribution occurs.

The amount of current harmonics produced by electronic loads such as a storage subsystem is limited by EN/IEC 61000-3-2, a standard set by the European Union (EU) and the International Electrical Committee (IEC). The standard divides the electronic loads into four classes: A, B, C and D. Each class has its own harmonic current limits. Class A is the default class, meaning if a product does not fall into the categories for class B, C or D, it is by default class A. Class A equipment includes all motor driven equipment, most “domestic” appliances and virtually all 3 phase equipment (<16 A rms per phase). Class B equipment includes all portable electric tools. Class C equipment includes all lighting products, including dimmers, with an active input power above 25 Watts. With the adoption of Amendment 14, the new EN/IEC 61000-3-2 standard limits Class D to TV's, PC's and PC monitors having a rated power range from 75 to 600 Watts.

Under the standard, very large systems and very small systems are essentially exempt. The problem arises within the mid-range systems that are not exempt. As indicated above, the power supplies within most data storage subsystems already contain active circuitry that compensates and adjusts power factors so that the current waveforms closely match the voltage waveforms. Thus, these storage subsystems by themselves would meet the EN/IEC 61000-3-2 standard. However, these storage subsystems may be later connected to adjunct equipment that, on its own, falls below the minimum levels. Nonetheless, enough of these accessory units may be added to a storage subsystem so that the aggregate load falls within the regulated area and the aggregate power factor is then affected by their presence, causing the aggregate system to become non-conforming. Such accessory units may be added by the user to a storage subsystem to support various forms of communication interfaces. For example, the accessory units may include fabric switches, system monitors, remote diagnostic support, and the like. It is unrealistic to require that vendors for these accessory units redesign their power supplies to approach a unity power factor when no regulation compels them to do so. On the other hand, suppliers of a storage subsystem are burdened with the responsibility of providing an aggregate system that complies with all regulations in force within the target sales arena. In these situations it becomes desirable to add power factor correction circuits to the internal power line distribution system of the storage subsystem to specifically correct the power factors of these potentially offending accessory units, thus making the aggregate storage subsystem conforming.

Power factor correction (PFC) circuits generally fall into two broad groups: passive and active. The passive PFC circuits usually have a combination of large capacitors, inductors and rectifiers that operate at the frequency of the AC power line to provide a resonant circuit which produces a sinusoidal current waveform. Passive PFC circuits may produce a high power factor, but lack efficiency. Active PFC circuits contain some form of high frequency switching converter for power processing of the voltage and current waveforms. Active PFC circuits typically use microchip technology to control operation of the power supply circuit and produce a sinusoidal current waveform. Because active PFC circuits operate at a frequency which is much higher than the AC power, the circuits can be smaller, lighter in weight, and more efficient than a passive circuit.

One active approach to achieving unity power factor has included such attempts as the use of large isolation transformers. This approach is the “Big Iron” method and essentially smothers the harmonics within the transformer, thus isolating the AC power line from the effects of significant harmonic content applied as reflections to the secondary windings of that transformer. The problem with this approach is the expense of purchasing such transformers and their weight. Isolation transformers for any respectable currents can easily weigh in at several dozens of pounds. These are weight penalties and cost penalties that greatly restrict product development efforts.

Another active approach involves the development of unity power factor (UPF) rectifiers that include active current shaping circuitry that causes currents drawn by the rectifiers from power lines to appear sinusoidal. However, the popularity of such devices in data storage subsystems has been limited because of the added cost of the current-shaping power converter at the input stage.

Thus, it is desirable to provide a light-weight and cost effective means to correct a power factor of a storage subsystem that may be later connected to one or more accessory units.

### SUMMARY OF THE INVENTION

Accordingly, the present invention is directed to a method and system for correcting a power factor of a storage subsystem. According to the present invention, a PFC circuit is utilized to solve the input current harmonics problem caused by offending accessory units that may be added to the storage subsystem. The PFC circuit may be characterized as a boost AC/AC power converter. The converter utilizes current shaping to achieve a unity power factor. In one embodiment, pulse width modulation (PWM) may be utilized to accomplish this shaping and thus controlling the flow of power. In another embodiment, pulse amplitude modulation (PAM) may be utilized to accomplish this shaping. According to the present invention, the modulation in the converter is controlled by a combination of an inner average-current loop and an outer voltage-control loop. Together, these control loops maintain a regulated output voltage while forcing the input current to be sinusoidal.

Using such a converter would eliminate the necessity of modifying either the power supply of accessory units or the internal power line distribution system within the storage subsystem. Such a converter may easily be retrofitted to an existing storage subsystem and might then be added to previously constructed storage subsystems.

### BRIEF DESCRIPTION OF THE DRAWINGS

The numerous advantages of the present invention may be better understood by those skilled in the art by reference to the accompanying figures in which:

FIG. 1 is a schematic diagram of an embodiment of a storage subsystem that is connected to one or more accessory units;

FIG. 2 is a schematic diagram of an embodiment of a storage subsystem shown in FIG. 1 having PFC circuitry in accordance with the present invention;

FIG. 3 is a schematic flowchart of an embodiment of a process to correct a power factor of a storage subsystem in accordance with the present invention;

FIG. 4 is a schematic diagram of an embodiment of a storage subsystem having PFC circuitry shown in FIG. 2, wherein an embodiment of the PFC circuitry utilizing the process shown in FIG. 3 is illustrated;

FIG. 5 is a schematic diagram of another embodiment of a storage subsystem shown in FIG. 1 having PFC circuitry in accordance with the present invention; and

FIG. 6 is a schematic diagram of an embodiment of a storage subsystem shown in FIG. 1 having a PFC adjusted electrical distribution section in accordance with the present invention.

### DETAILED DESCRIPTION OF THE INVENTION

Reference will now be made in detail to the presently preferred embodiments of the invention, examples of which are illustrated in the accompanying drawings.

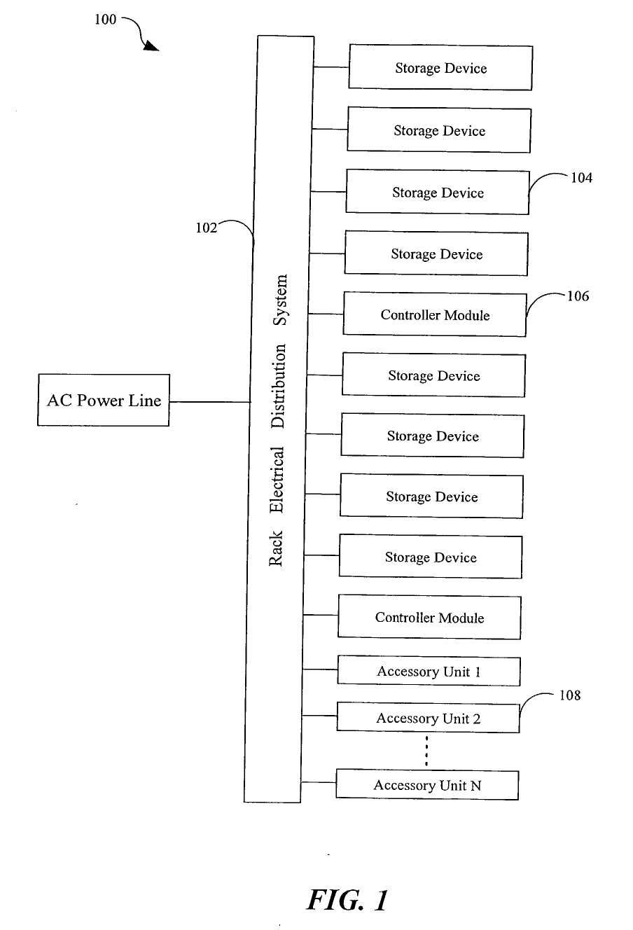

Referring first to FIG. 1, a schematic diagram of an embodiment of a storage subsystem that is connected to one or more accessory units is shown. The storage subsystem 100 may include a rack electrical distribution system 102, one or more controller modules 106, and one or more storage devices 104. Storage devices 104 may include disks, disk arrays, CD-ROMs, tapes, tape arrays, media loaders, and the like. For example, they may be multiple hard disks organized under the technique of RAID (Redundant Array of Independent Disks). It is understood that controller modules 106 and storage devices 104 may be complex enough that they are considered to be subsystems in their own right. It is also understood that the storage subsystem 100 may be part of SAN (Storage Array Network) attached storage or NAS (Network Attached Storage). The rack electrical distribution system 102 receives input power from the AC power line and supplies power to storage devices 104 and controller modules 106. Storage devices 104 and controller modules 106 are high current devices and conventionally have their own PFC circuitry resident within each supply. Consequently the storage subsystem 100 would meet the EN/IEC 61000-3-2 standard, exclusive of accessory units. However, users may add one or more accessory units 108 to the storage subsystem 100 to support various forms of communication interfaces. For example, they may add fabric switches, system monitors, remote diagnostic support, and the like. These accessory units 108 receive their power supply from the rack electrical distribution system 102 and may not include PFC circuitry because of their power consumption levels. Because PFC circuitry in the storage devices 104 and controller modules 106 is not capable of conditioning current to accessory units 108, the power factor of the aggregate storage subsystem may be adversely affected, and the aggregate storage subsystem may become nonconforming.

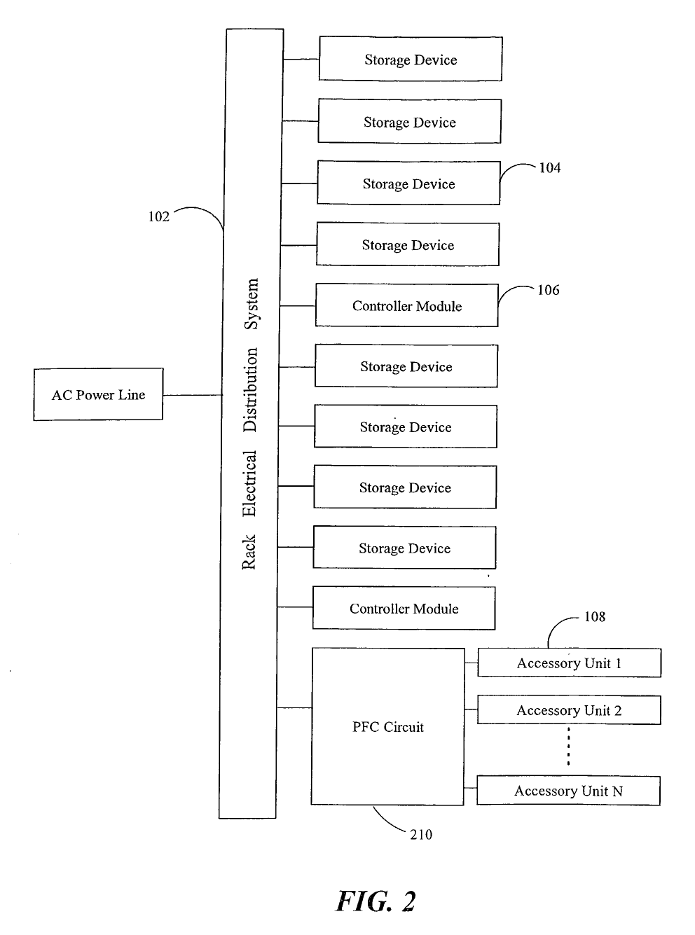

Referring to FIG. 2, a schematic diagram of an embodiment of a storage subsystem shown in FIG. 1 having PFC circuitry in accordance with the present invention is shown. PFC circuitry 210 is added between the rack electrical distribution system 102 and accessory units 108 to correct the power factors of the accessory units 108 so as to make the aggregate storage subsystem conforming. The PFC circuitry 210 receives input power from the rack electrical distribution system 102 and supplies power to accessory units.

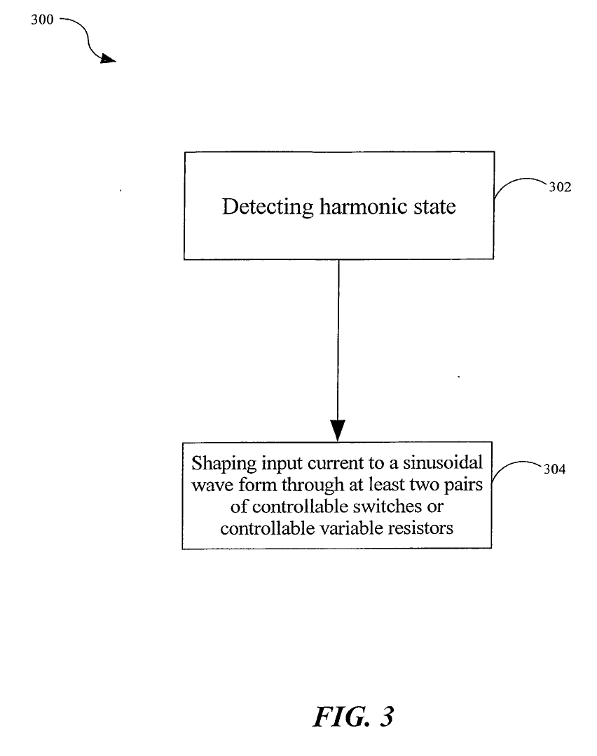

Referring now to FIG. 3, a schematic flowchart of an embodiment of a process to correct a power factor of a storage subsystem in accordance with the present invention is shown. The process 300 may include detecting a harmonic state of one or more accessory units under power (step 302), and shaping input current to a sinusoidal waveform through at least two pairs of controllable switches or controllable variable resistors (step 304). In one embodiment, step 304 functions such that the magnitude of input current increases when one pair of controllable switches is turned on and decreases when another pair of controllable switches is turned on.

The relationship between the current and voltage, on a time varying basis, is essentially a relationship dependant upon a constant times “R” where “R” represents the effective resistance of one or more accessory units under power. If this value “R” is a fixed number, then the one or more accessory units under power may exhibit a power factor of one. In order to be able to control the power factor over time, the system interpretation of “R” needs to be continually updated and improved. For example, the ratio (difference) between the desirable level of input current and the actual level of input current may be used as the intelligence that drives the states of controllable switches or controllable variable resistors in the circuit. These values may be sensed and used directly or their derivatives may be used to achieve this end.

An inductor by itself may be used as a sensor if the voltage drop across it is measured. The integral equation defining the operation of an inductor relates the voltage drop across the inductor to its inductance times the time integral of the current. Since the equation relates to the integral, the derivative may be electrically generated, possibly by using a capacitor and an operational amplification circuit as a buffer. Once the derivative is obtained, a time-varying value that directly represents the current being drawn through the inductor may be achieved.

A current sensing resistor may also be used. But the sensing resistor would be unusual. It would probably be a very low valued, high wattage device. The logic of adding sense resistances to input current paths may not be sound for the voltage levels anticipated in a storage subsystem. Heating may ruin the accuracy of such a sensing resistor unless very special devices with extremely unusual temperature coefficients are chosen.

The voltage across the one or more accessory units under power also needs to be monitored. This is an alternating current and the monitor need be capable of accurately reading positive and negative polarities of significant magnitude. This may be done by using a simple voltage divider and sampling at a substantially lower, manageable voltage level. Since the divider resistances may be quite high, little current flows through the divider and heating problems can be avoided. Accuracy here is not as critical as it would have been in a current sensing resistor. Since there are typically an upper leg and a lower leg on a resistive divider, it is the ratio between the two legs that defines the sample voltage. Thus the sampled voltage originating at the junction of a pair of resistors having similar temperature coefficients may drift little. The temperature coefficients may affect the nominal component values in such a way as to affect their ratio little.

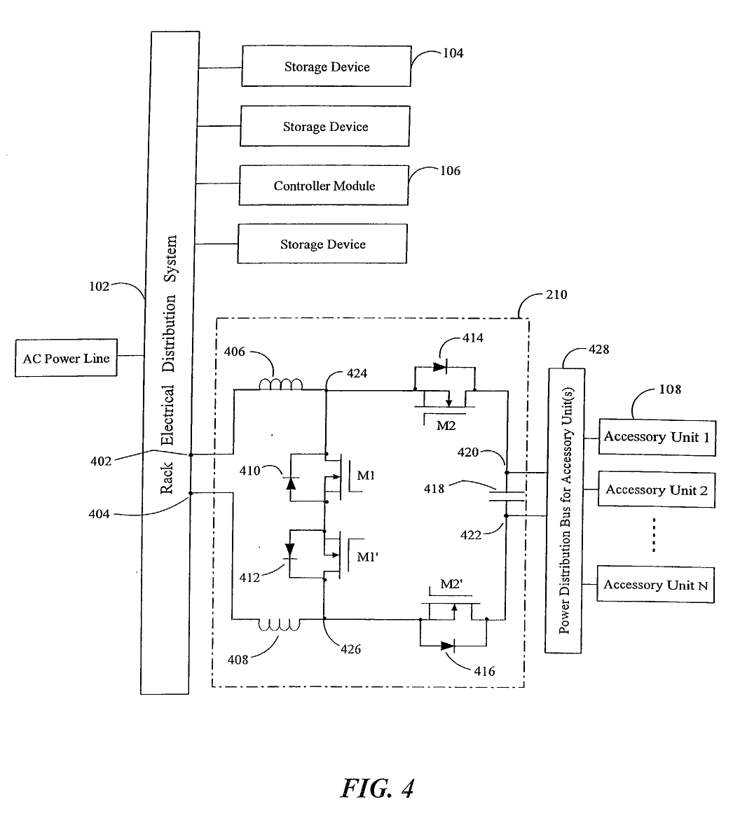

FIG. 4 is a schematic diagram of an embodiment of a storage subsystem having PFC circuitry shown in FIG. 2, wherein an embodiment of the PFC circuitry utilizing the process shown in FIG. 3 is illustrated. The circuit 210 receives input power from the rack electrical distribution system 102 at its input terminals 402, 404 and supplies power to the accessory units 108 through a power distribution bus 428. Power distribution bus 428 may include a power strip with multiple outlets. A boost inductor 406 is connected between the input terminal 402 and node 424. Also connected to node 424 are MOSFET's M1 and M2. The source terminal of M1 is connected to MOSFET M1′ which in turn is connected to node 426. The drain terminal of M2 is connected to output terminal 420. A second boost inductor 408 is connected between the input terminal 404 and node 426. Also connected to node 426 is MOSFET M2′ whose drain terminal is connected to output terminal 422. Capacitor 418 is connected between output terminals 420, 422. Diodes 410, 412, 414, and 416 are connected across M1, M1′, M2, and M2′, respectively, and enforce and adjust polarity. Diodes 410, 412, 414, and 416 may be basic silicon Shottkey diodes, high voltage Shottkey barrier diodes based on silicon carbide, or the like. Sizing for the boost inductors 406, 408 and MOSFET's M1, M2, M1′, M2′ may be determined roughly by the anticipated input current flow.

The power factor correction circuit 210 may be characterized as a boost AC/AC power converter. It may utilize current shaping to achieve a unity power factor. In one embodiment, it may use pulse width modulation (PWM) as a means of accomplishing this shaping and thus controlling the flow of power. In a second embodiment, pulse amplitude modulation (PAM) may be utilized to accomplish this shaping. The modulation in the circuit 210 is controlled by a combination of an inner average-current loop which includes M1 and M1′and an outer voltage-control loop which includes M2 and M2′. Together, these control loops maintain a regulated output voltage while forcing the input current to be sinusoidal. For example, when M1 and M1′ are turned on, the magnitude of source current through the boost inductors 406, 408 may increase. When M2 and M2′ are turned on, the magnitude of the current through the boost inductors 406, 408 may decrease. Hence, by suitably modulating the switching of these MOSFET's, the source current through the boost inductors 406, 408 can be controlled to be sinusoidal.

It is understood that the use of MOSFET's M1, M1′, M2, and M2′ as controllable switching means is exemplary. Those of ordinary skill in the art will understand that other switching means such as bipolar transistors may also be used without deviating from the scope and spirit of the present invention. It is also understood that MOSFET's M1, M1′, M2, and M2′ may also function as controllable variable resistors to accomplish the same goal without departing from the scope and spirit of the present invention.

A main function provided by the PFC circuit 210 is to prevent the injection of harmonics onto the power line and to elevate the aggregate power factor to a value approaching unity. Using such a circuit may eliminate the necessity of modifying either the power supply of accessory units 108 or the rack electrical distribution system 102. Instead, the circuit 210 could be constructed as a plug-in unit that could be inserted between the rack electrical distribution system 102 and accessory units 108. Such a circuit can easily be retrofitted to an existing storage subsystem and might then be added to previously constructed storage subsystems.

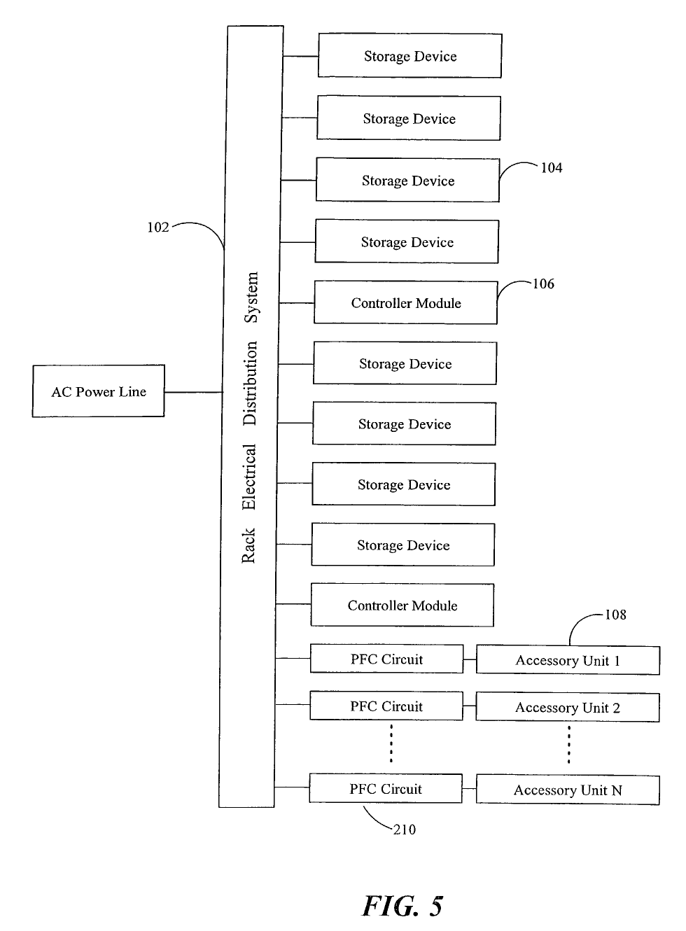

Referring to FIG. 5, a schematic diagram of another embodiment of a storage subsystem shown in FIG. 1 having PFC circuitry in accordance with the present invention is shown. Here, for each accessory unit 108, a separate PFC circuit 210 shown in FIG. 4 is used to correct its power factor.

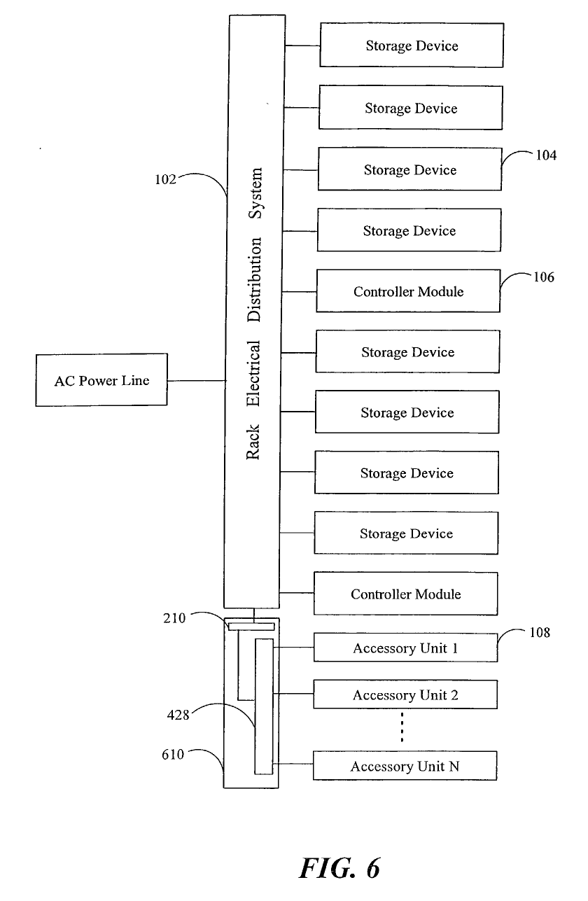

Referring now to FIG. 6, a schematic diagram of an embodiment of a storage subsystem shown in FIG. 1 having a PFC adjusted electrical distribution section in accordance with the present invention is shown. The PFC adjusted electrical distribution section 610 receives its power from the rack electrical distribution system 102 and through its multiple outlets supplies power to one or more accessory units 108. The PFC adjusted electrical distribution section 610 may include the PFC circuitry 210 and the power distribution bus 428, both of which are shown in FIG. 4. The PFC adjusted electrical distribution section 610 will correct the power factors of accessory units 108, thus making the aggregate storage subsystem conforming.

It is believed that a method and system for correcting a power factor of a storage subsystem of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages, the form herein before described being merely an explanatory embodiment thereof. It is the intention of the following claims to encompass and include such changes.

What is claimed is:

1. A storage subsystem having power factor correction circuitry, comprising:
(a) at least one data storage device for storing digital information;
(b) at least one storage controller module for controlling digital data storage on said at least one data storage device; and
(c) an electrical distribution system to supply power to said at least one data storage device and said at least one storage controller module, said electrical distribution system including said power factor correction circuitry for correcting power factors of one or more accessory units when coupled to said storage subsystem.

2. The storage subsystem having power factor correction circuitry as claimed in claim 1, wherein said at least one data storage device comprises hard disks organized under the technique of RAID (Redundant Array of Independent Disks).

3. The storage subsystem having power factor correction circuitry as claimed in claim 1, wherein said power factor correction circuitry comprises active power factor correction circuitry.

4. The storage subsystem having power factor correction circuitry as claimed in claim 1, wherein said power factor correction circuitry comprises:
(a) a first input terminal and a second input terminal for connecting to said electrical distribution system;
(b) a first output terminal and a second output terminal for coupling to said one or more accessory units;
(c) a capacitor connected between said first output terminal and said second output terminal;
(d) a first boost inductor connected to said first input terminal and a second boost inductor connected to said second input terminal;
(e) an inner average-current loop comprising a first controllable switch and a second controllable switch connected in series between said first boost inductor and said second boost inductor to increase magnitude of current through said first and second boost inductors when said first and second controllable switches are turned on; and
(f) an outer voltage-control loop comprising a third controllable switch which is connected between said first output terminal and a junction of said first boost inductor and said first controllable switch, and a fourth controllable switch which is connected between said second output terminal and a junction of said second boost inductor and said second controllable switch to decrease magnitude of the current through said first and second boost inductors when said third and fourth controllable switches are turned on.

5. The storage subsystem having power factor correction circuitry as claimed in claim 4 whereby said first and second controllable switches and said third and fourth controllable switches are switched on and off periodically to effect PWM (Pulse Width Modulation) to shape the current through said first and second boost inductors to a sinusoidal waveform while maintaining a regulated output voltage.

6. The storage subsystem having power factor correction circuitry as claimed in claim 5, wherein said first, second, third, and fourth controllable switches are MOSFET's.

7. The storage subsystem having power factor correction circuitry as claimed in claim 6, wherein said power factor correction circuitry further comprises a first diode connected across said first MOSFET, a second diode connected across said second MOSFET, a third diode connected across said third MOSFET, and a fourth diode connected across said fourth MOSFET to enforce and adjust polarity.

8. The storage subsystem having power factor correction circuitry as claimed in claim 4 whereby said first and second controllable switches and said third and fourth controllable switches are switched on and off periodically to effect PAM (Pulse Amplitude Modulation) to shape the current through said first and second boost inductors to a sinusoidal waveform while maintaining a regulated output voltage.

9. The storage subsystem having power factor correction circuitry as claimed in claim 8, wherein said first, second, third, and fourth controllable switches are MOSFET'S.

10. The storage subsystem having power factor correction circuitry as claimed in claim 9, wherein said power factor correction circuitry further comprises a first diode connected across said first MOSFET, a second diode connected across said second MOSFET, a third diode connected across said third MOSFET, and a fourth diode connected across said fourth MOSFET to enforce and adjust polarity.

11. The storage subsystem having power factor correction circuitry as claimed in claim 1, wherein said power factor correction circuitry comprises:
(a) a first input terminal and a second input terminal for connecting to said electrical distribution system;
(b) a first output terminal and a second output terminal for coupling to said one or more accessory units;
(c) a capacitor connected between said first output terminal and said second output terminal;
(d) a first boost inductor connected to said first input terminal and a second boost inductor connected to said second input terminal;
(e) an inner average-current loop comprising a first controllable variable resistor and a second controllable variable resistor connected in series between said first boost inductor and said second boost inductor to increase magnitude of current through said first and second boost inductors when said first and second controllable variable resistors are adjusted; and
(f) an outer voltage-control loop comprising a third controllable variable resistor which is connected between said first output terminal and a junction of said first boost inductor and said first controllable variable resistor, and a fourth controllable variable resistor which is connected between said second output terminal and a junction of said second boost inductor and said second controllable variable resistor to decrease magnitude of the current through said first and second boost inductors when said third and fourth controllable variable resistors are adjusted.

12. The storage subsystem having power factor correction circuitry as claimed in claim 11 whereby said first and second controllable variable resistors and said third and fourth controllable variable resistors are adjusted periodically to effect PWM (Pulse Width Modulation) to shape the current through said first and second boost inductors to a sinusoidal waveform while maintaining a regulated output voltage.

13. The storage subsystem having power factor correction circuitry as claimed in claim 12, wherein said first, second, third, and fourth controllable variable resistors are MOSFET's.

14. The storage subsystem having power factor correction circuitry as claimed in claim 11 whereby said first and second controllable variable resistors and said third and fourth controllable variable resistors are adjusted periodically to effect PAM (Pulse Amplitude Modulation) to shape the current through said first and second boost inductors to a sinusoidal waveform while maintaining a regulated output voltage.

15. The storage subsystem having power factor correction circuitry as claimed in claim 14, wherein said first, second, third, and fourth controllable variable resistors are MOSFET's.

16. A storage subsystem having power factor correction circuitry, comprising:
(a) at least one data storage device for storing digital information;
(b) at least one storage controller module for controlling digital data storage on said at least one data storage device;
(c) an electrical distribution system to supply power to said at least one data storage device and said at least one storage controller module; and
(d) a power factor correction adjusted power distribution section to supply power to one or more accessory units when coupled to said storage subsystem, said power factor correction adjusted power distribution section receiving power from said electrical distribution system and including said power factor correction circuitry for correcting power factors of said one or more accessory units.

17. The storage subsystem having power factor correction circuitry as claimed in claim 16, wherein said at least one data storage device comprises hard disks organized under the technique of RAID (Redundant Array of Independent Disks).

18. The storage subsystem having power factor correction circuitry as claimed in claim 16, wherein said power factor correction circuitry comprises active power factor correction circuitry.

19. The storage subsystem having power factor correction circuitry as claimed in claim 16, wherein said power factor correction circuitry comprises:
(a) a first input terminal and a second input terminal for connecting to said electrical distribution system;
(b) a first output terminal and a second output terminal for coupling to said one or more accessory units;
(c) a capacitor connected between said first output terminal and said second output terminal;
(d) a first boost inductor connected to said first input terminal and a second boost inductor connected to said second input terminal;
(e) an inner average-current loop comprising a first controllable switch and a second controllable switch connected in series between said first boost inductor and said second boost inductor to increase magnitude of current through said first and second boost inductors when said first and second controllable switches are turned on; and
(f) an outer voltage-control loop comprising a third controllable switch which is connected between said first output terminal and a junction of said first boost inductor and said first controllable switch, and a fourth controllable switch which is connected between said second output terminal and a junction of said second boost inductor and said second controllable switch to decrease magnitude of the current through said first and second boost inductors when said third and fourth controllable switches are turned on.

20. The storage subsystem having power factor correction circuitry as claimed in claim 19 whereby said first and second controllable switches and said third and fourth controllable switches are switched on and off periodically to effect PWM (Pulse Width Modulation) to shape the current through said first and second boost inductors to a sinusoidal waveform while maintaining a regulated output voltage.

21. The storage subsystem having power factor correction circuitry as claimed in claim 20, wherein said first, second, third, and fourth controllable switches are MOSFET's.

22. The storage subsystem having power factor correction circuitry as claimed in claim 21, wherein said power factor correction circuitry further comprises a first diode connected across said first MOSFET, a second diode connected across said second MOSFET, a third diode connected across said third MOSFET, and a fourth diode connected across said fourth MOSFET to enforce and adjust polarity.

23. The storage subsystem having power factor correction circuitry as claimed in claim 19 whereby said first and second controllable switches and said third and fourth controllable switches are switched on and off periodically to effect PAM (Pulse Amplitude Modulation) to shape the current through said first and second boost inductors to a sinusoidal waveform while maintaining a regulated output voltage.

24. The storage subsystem having power factor correction circuitry as claimed in claim 23, wherein said first, second, third, and fourth controllable switches are MOSFET's.

25. The storage subsystem having power factor correction circuitry as claimed in claim 24, wherein said power factor correction circuitry further comprises a first diode connected across said first MOSFET, a second diode connected across said second MOSFET, a third diode connected across said third MOSFET, and a fourth diode connected across said fourth MOSFET to enforce and adjust polarity.

26. The storage subsystem having power factor correction circuitry as claimed in claim 16, wherein said power factor correction circuitry comprises:
(a) a first input terminal and a second input terminal for connecting to said electrical distribution system;
(b) a first output terminal and a second output terminal for coupling to said one or more accessory units;
(c) a capacitor connected between said first output terminal and said second output terminal;
(d) a first boost inductor connected to said first input terminal and a second boost inductor connected to said second input terminal;
(e) an inner average-current loop comprising a first controllable variable resistor and a second controllable variable resistor connected in series between said first boost inductor and said second boost inductor to increase magnitude of current through said first and second boost inductors when said first and second controllable variable resistors are adjusted; and
(f) an outer voltage-control loop comprising a third controllable variable resistor which is connected between said first output terminal and a junction of said first boost inductor and said first controllable variable resistor, and a fourth controllable variable resistor which is connected between said second output terminal and a junction of said second boost inductor and said second controllable variable resistor to decrease magnitude of the current through said first and second boost inductors when said third and fourth controllable variable resistors are adjusted.

27. The storage subsystem having power factor correction circuitry as claimed in claim 26 whereby said first and second controllable variable resistors and said third and fourth controllable variable resistors are adjusted periodically to effect PWM (Pulse Width Modulation) to shape the current through said first and second boost inductors to a sinusoidal waveform while maintaining a regulated output voltage.

28. The storage subsystem having power factor correction circuitry as claimed in claim 27, wherein said first, second, third, and fourth controllable variable resistors are MOSFET's.

29. The storage subsystem having power factor correction circuitry as claimed in claim 28 whereby said first and second controllable variable resistors and said third and fourth controllable variable resistors are adjusted periodically to effect PAM (Pulse Amplitude Modulation) to shape the current through said first and second boost inductors to a sinusoidal waveform while maintaining a regulated output voltage.

30. The storage subsystem having power factor correction circuitry as claimed in claim 29, wherein said first, second, third, and fourth controllable variable resistors are MOSFET's.

31. A method of correcting a power factor of a storage subsystem connected to one or more accessory units, comprising the steps of:
(a) supplying an AC voltage to power factor correction circuitry having first and second boost inductors, a capacitor, and first pair and second pair of controllable switch means;
(b) detecting a harmonic state of said one or more accessory units; and
(c) shaping input current to a sinusoidal waveform through said first pair and said second pair of controllable switch means whereby magnitude of current through said first and second boost inductors is increased when said first pair of controllable switch means is turned on and is decreased when said second pair of controllable switch means is turned on.

32. The method for correcting a power factor of a storage subsystem as claimed in claim 31 whereby said shaping step further comprises controlling on and off of said first pair and said second pair of controllable switch means to effect PWM (Pulse Width Modulation) to shape said current through said first and second boost inductors to a sinusoidal waveform while maintaining a regulated output voltage.

33. The method for correcting a power factor of a storage subsystem as claimed in claim 31 whereby said shaping step further comprises controlling on and off of said first pair and said second pair of controllable switch means to effect PAM (Pulse Amplitude Modulation) to shape said current through said first and second boost inductors to a sinusoidal waveform while maintaining a regulated output voltage.

34. A system for correcting a power factor of a storage subsystem, comprising:
(a) means for supplying an AC voltage to a power factor correction circuit having first and second boost inductors, a capacitor, and first pair and second pair of controllable switch means;
(b) means for detecting a harmonic state of said storage subsystem that is connected to at least one accessory unit; and
(c) means for shaping input current to a sinusoidal waveform through said first pair and said second pair of controllable switch means whereby magnitude of current through said first and second boost inductors is increased when said first pair of controllable switch means is turned on and is decreased when said second pair of controllable switch means is turned on.

35. The system for correcting a power factor of a storage subsystem as claimed in claim 34 whereby said means for shaping input current further comprises means for controlling on and off of said first pair and said second pair of controllable switch means to effect PWM (Pulse Width Modulation) to shape said current through said first and second boost inductors to a sinusoidal waveform while maintaining a regulated output voltage.

36. The system for correcting a power factor of a storage subsystem as claimed in claim 34 whereby said means for shaping input current further comprises means for controlling on and off of said first pair and said second pair of controllable switch means to effect PAM (Pulse Amplitude Modulation) to shape said current through said first and second boost inductors to a sinusoidal waveform while maintaining a regulated output voltage.

37. A method of correcting a power factor of a storage subsystem connected to one or more accessory units, comprising the steps of:
(a) supplying an AC voltage to power factor correction circuitry having first and second boost inductors, a capacitor, and first pair and second pair of controllable variable resistors;
(b) detecting a harmonic state of said one or more accessory units; and
(c) shaping input current to a sinusoidal waveform through said first pair and said second pair of controllable variable resistors whereby magnitude of current through said first and second boost inductors is adjusted when said first and second pair of controllable variable resistors are adjusted.

38. The method for correcting a power factor of a storage subsystem as claimed in claim 37 whereby said shaping step further comprises adjusting said first pair and said second pair of controllable variable resistors to effect PWM (Pulse Width Modulation) to shape said current through said first and second boost inductors to a sinusoidal waveform while maintaining a regulated output voltage.

39. The method for correcting a power factor of a storage subsystem as claimed in claim 37 whereby said shaping step further comprises adjusting said first pair and said second pair of controllable variable resistors to effect PAM (Pulse Amplitude Modulation) to shape said current through said first and second boost inductors to a sinusoidal waveform while maintaining a regulated output voltage.

40. A system for correcting a power factor of a storage subsystem, comprising:
(a) means for supplying an AC voltage to a power factor correction circuit having first and second boost inductors, a capacitor, and first pair and second pair of controllable variable resistors;
(b) means for detecting a harmonic state of said storage subsystem that is connected to at least one accessory unit; and
(c) means for shaping input current to a sinusoidal waveform through said first pair and said second pair of controllable variable resistors whereby magnitude of current through said first and second boost inductors is adjusted when said first and said second pair of controllable variable resistors are adjusted.

41. The system for correcting a power factor of a storage subsystem as claimed in claim 40 whereby said means for shaping input current further comprises means for adjusting said first pair and said second pair of controllable variable resistors to effect PWM (Pulse Width Modulation) to shape said current through said first and second boost inductors to a sinusoidal waveform while maintaining a regulated output voltage.

42. The system for correcting a power factor of a storage subsystem as claimed in claim 40 whereby said means for shaping input current further comprises means for adjusting said first pair and said second pair of controllable variable resistors to effect PAM (Pulse Amplitude Modulation) to shape said current through said first and second boost inductors to a sinusoidal waveform while maintaining a regulated output voltage.
